(19) United States
(12) Patent Application Publication
(10) Pub. No.: US 2017/0215645 A1
(43) Pub. Date: Aug. 3, 2017

(54) A DEVICE FOR FROTHING MILK

(71) Applicant: CARIMALI S.P.A., Bergamo (BG) (IT)

(72) Inventors: Andrea DOGLIONI MAJER, Bergamo (BG) (IT); Massimo PELLETTA, Bergamo (BG) (IT)

(21) Appl. No.: 15/328,320

(22) PCT Filed: Jun. 3, 2015
(86) PCT No.: PCT/IB2015/054208

§ 371 Date: Jan. 23, 2017

(30) Foreign Application Priority Data
Jul. 31, 2014 (IT) MI2014A001402

(51) Int. Cl. A47J 43/046; B01F 7/00; A47J 31/44; B01F 13/08; B01F 13/10; A01J 11/04; B01F 3/04; B01F 7/28

(52) U.S. Cl. CPC A47J 43/0465; B01F 3/04453; B01F 7/00216; B01F 7/00633; B01F 7/28; B01F 13/0827; B01F 13/1016; A01J 11/04; A47J 31/4485; B01F 2215/0006; B01F 2215/0014; B01F 2215/0022

(57) ABSTRACT

A device for frothing milk and liquid food is disclosed having a frothing rotor and a motor adapted to rotate the frothing rotor, a seat adapted to substantially entirely contain the frothing rotor an inlet for feeding the milk or liquid food into the seat, an air inlet and an outlet of the milk or liquid food from the seat.

The present invention relates to a device for frothing milk and liquid food. In more detail, the invention relates to a device for frothing milk when preparing beverages containing frothed milk, such as cappuccino, latte macchiato and the like. The invention generally applies to liquid food adapted to be emulsified, that is to say frothed. With frothing is meant a process in which air is incorporated into a liquid, i.e. an emulsion of air is formed in the liquid, resulting in a fine dispersion of air bubbles in the frothed liquid.

Herein “milk” means both “pure” milk and milk-based liquids. Milk can be animal milk, for example cow's milk, or plant milk, for example soy milk. The invention can be also applied to different liquid food adapted to be emulsified by incorporating air, i.e. frothed. Milk froth is an essential component for various kinds of beverages, such as cappuccino.

Machines for preparing beverages, intended to dispense cold or hot milk having a certain amount of froth, i.e. of frothed milk, are known; in order to generate this froth, as known, a given amount of air should be injected into the milk while the liquid is agitated. The milk is generally heated by injecting vapor.

According to a first known technique, after placing milk in a container, a mixer is inserted therein. Typically, such a mixer has a helical-shaped rotor contained within a seat open at the bottom so as to allow this rotor to be put directly in contact with milk. The rotation of the rotor inserted in the container agitates milk, mixing the latter with ambient air thereby forming frothed milk.

According to another known technique, a duct emitting vapor is submerged into the milk held in the container, thereby forming frothed milk; this method is generally used in commercial and HoReCa machines.

The above described methods have several drawbacks. First of all, the operations of the mixer or of the vapor feeding duct are manually controlled, or in any case have to be attended by an operator. Furthermore, the frothed milk remains in the container and the right dose thereof has to be manually poured in the beverage or anyway manually moved to another place. Furthermore, the considerable number of components of known helical mixers makes difficult to clean the mixer itself.

Therefore, devices to be placed in an automatic machine for automatically dispensing a given and predetermined amount of frothed milk have been designed. In one embodiment, milk is fed through a dispensing duct having a second air feeding duct connected thereto. Milk passing through the dispensing duct generates a depression inside the air feeding duct so that, under shaking conditions, the same air is drawn back inside the dispensing duct of the milk. It is therefore possible to mix air and milk to create froth. According to a variation of this solution, air is forced to enter the dispensing duct of the milk. Alternatively, it is known to inject vapor, rather than air, inside the milk dispensing duct, so as to froth and heat up the milk at the same time, thereby allowing to dispense hot milk with froth.

However, the effect of emulsifying, i.e. frothing, by means of this kind of machines is an amount of froth not completely satisfactory.

All the known systems also have the problem that the frothing device requires an accurate periodic cleaning in order to prevent contamination of the milk. In fact, as known in the art, the tools for treating milk have to be subjected to frequent and accurate cleaning cycles, in order to prevent bacteria from proliferate in milk residues.

U.S. Pat. No. 3,514,079 describes a rotor machine for emulsifying mayonnaise. A frustoconical rotor is inserted in a respective seat with little clearance. This clearance can be adjusted by axially translating the rotor.

U.S. Pat. No. 2,577,247 describes a machine for emulsifying milk without injecting air, i.e. for making inseparable the fat portion and the aqueous portion of the milk. This is achieved by pumping milk towards a rotor and applying an electric charge thereto.

U.S. Pat. No. 4,066,246 describes a mixer for ducts to mix liquid food.

These devices are not suitable for frothing milk, i.e. for injecting air therein so as to form froth.

It is therefore an object of the present invention to solve the above listed problems of the known art. In particular, it is an object of the present invention to provide a frother, or frothing device, for liquid food, in particular milk, allowing a high degree of emulsion of the beverage, i.e. allowing a satisfactory degree of emulsion to be created in an automatic and iterative way.

It is another object of the present invention to provide a frothing device (air-liquid emulsifier) for liquid food, in particular milk, easy to be manufactured and having a limited number of components which can be easily cleaned.

It is a further object of the present invention to provide a device for frothing milk, which allows to selectively dispense frothed hot or cold milk in a simple and effective way.

The present invention achieves these and other objects by means of a frothing device according to claim 1.

Preferred aspects of the present invention are set forth in the dependent claims.

A further object of the present invention is a machine for dispensing beverages comprising the frothing device according to the present invention, and dedicated lines for feeding milk to be frothed, vapor and air to the frothing device and for dispensing frothed milk from the device itself.

A further object of the invention is a method for preparing a beverage in which a liquid, especially milk, is frothed in a device according to the invention.

As explained below referring to figures, the frothing device of the invention provides a tiny and uniform dispersion of air in the liquid; this results in a froth having a much more resistant and durable structure with respect to that provided by the prior art. This advantage takes place also in frothing cold milk. Furthermore, the invention allows as well to satisfactorily froth plant milks, such as soy milk or the like.

Hereinafter, referring to the appended figures, exemplary and non-limiting embodiments of the present invention will be described, wherein:

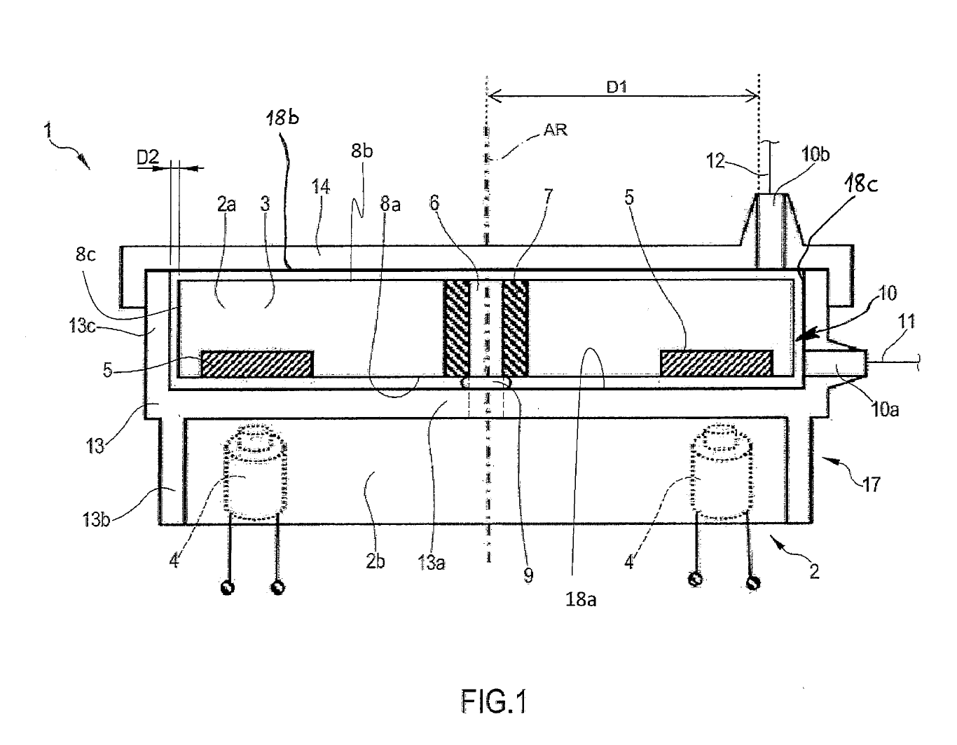

FIG. 1 is a schematic sectional view of a frothing device according to the present invention;

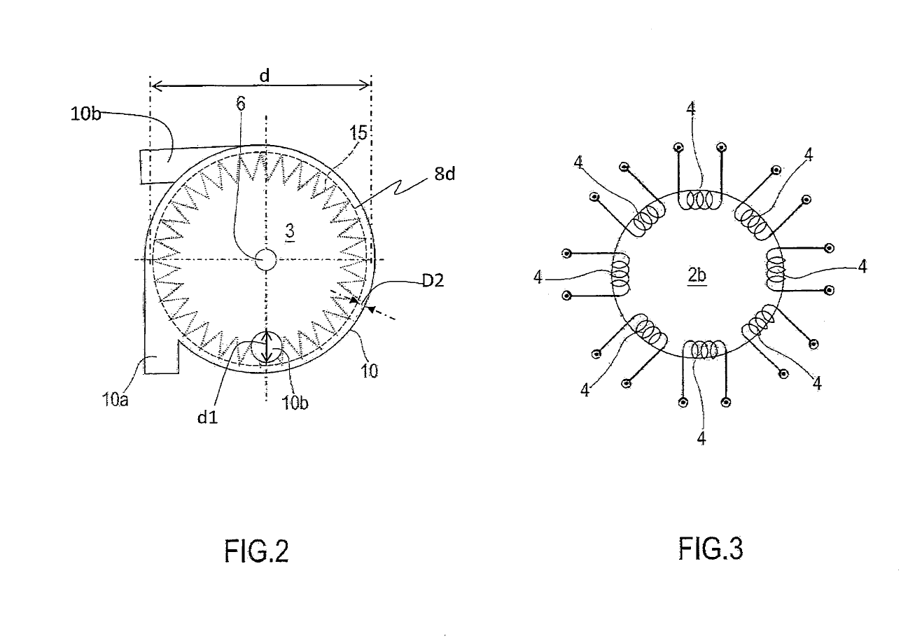

FIG. 2 is a schematic plan view of frothing rotor according to a variation of the embodiment of the present invention;

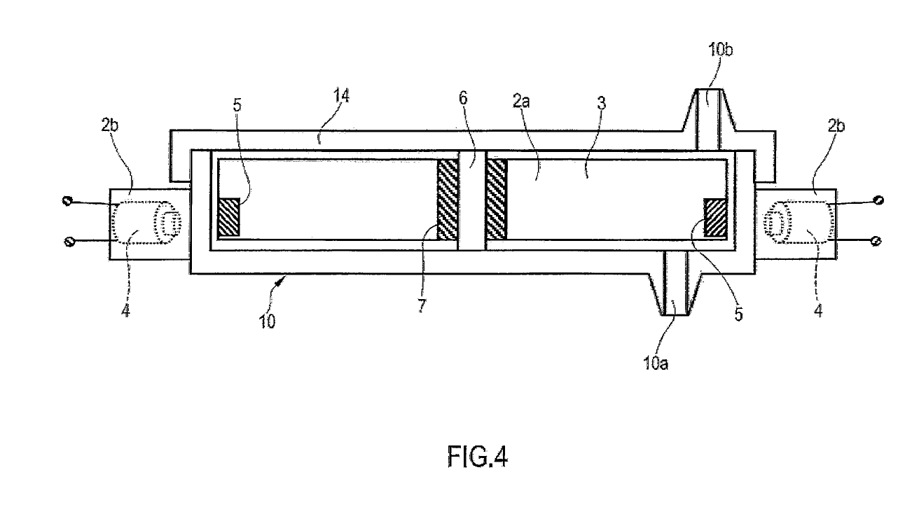

FIG. 3 is a schematic plan view of a stator of a motor according to the embodiment of FIG. 1;

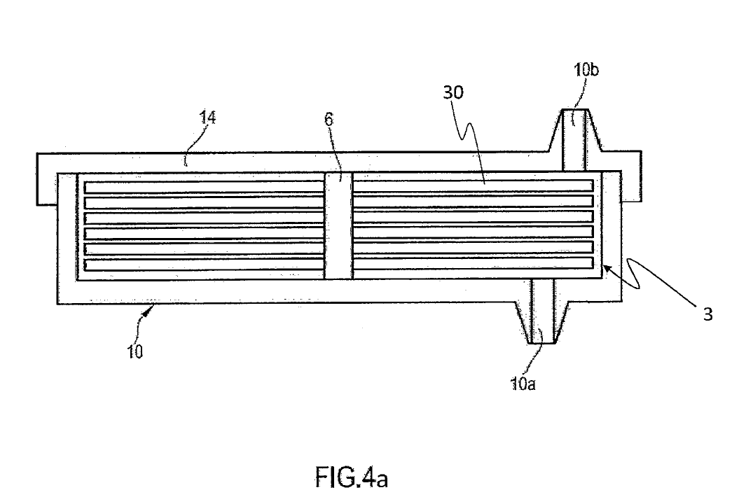

FIG. 4 is a schematic view of an embodiment alternative to the embodiment of FIG. 1;

FIG. 4a is a schematic view of a further alternative embodiment, in which the rotor is composed of a plurality of disks;

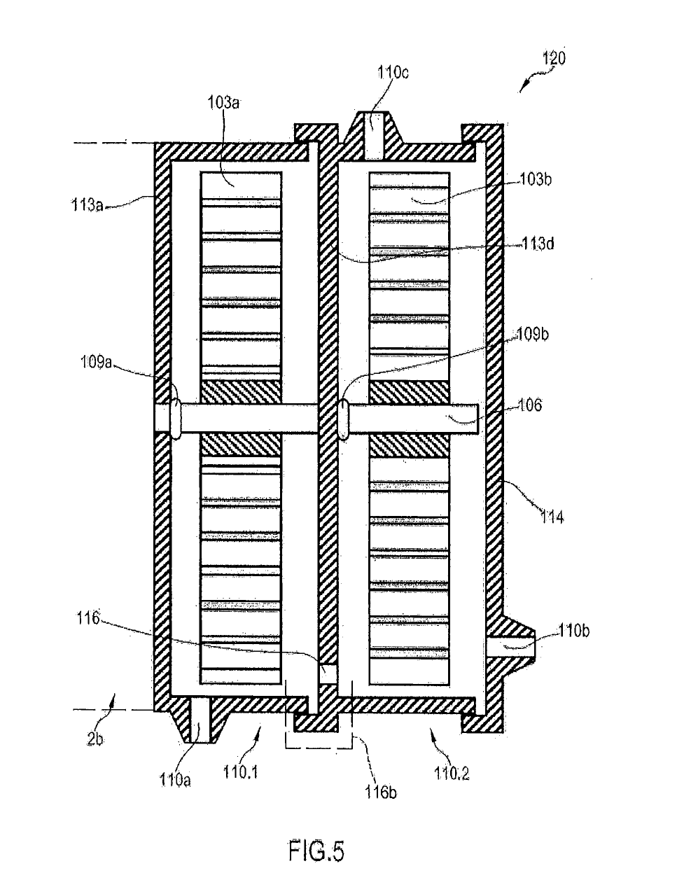

FIG. 5 is a schematic sectional view of a further embodiment according to the present invention;

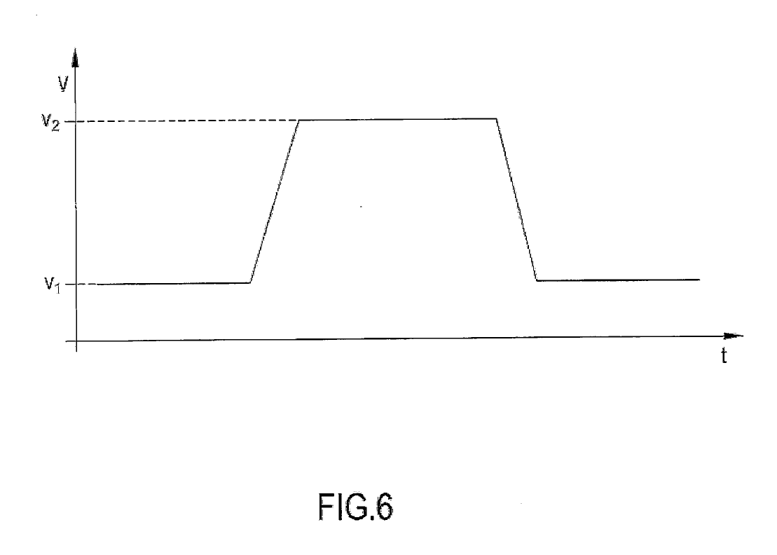

FIG. 6 is a schematic view of a speed profile of a frothing rotor according to the present invention;

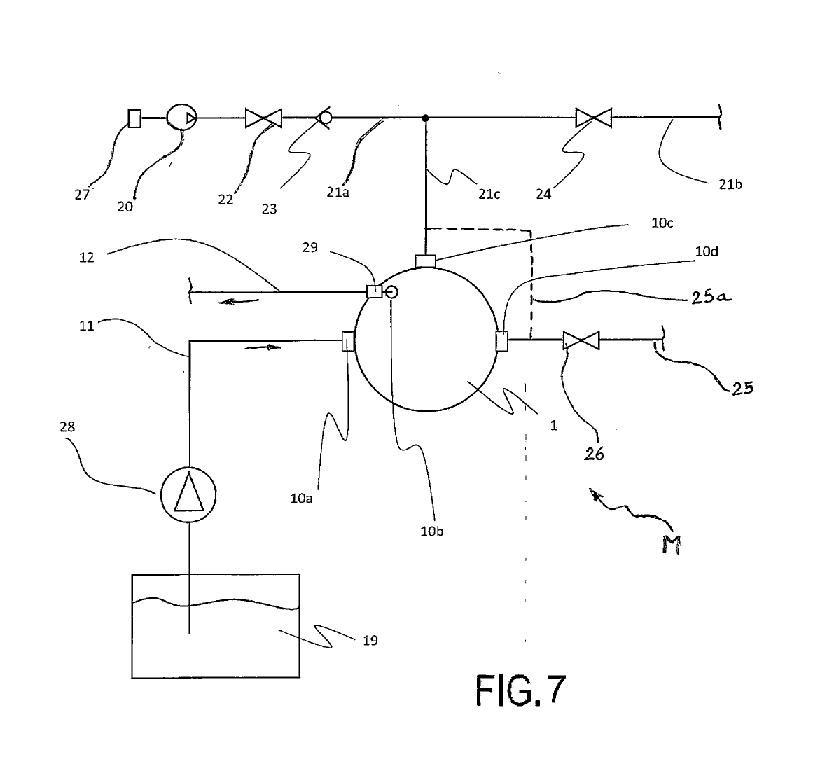

FIG. 7 is a schematic view of components of a machine for dispensing beverages provided with a frothing device according to the invention;

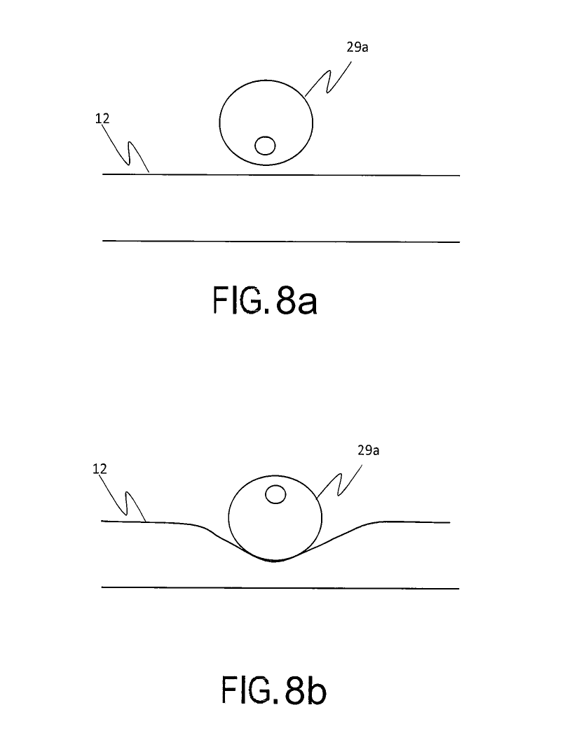

FIGS. 8a and 8b are schematic views of an embodiment of means for adjusting the flow rate of milk.

Referring to the appended figures, according to the present invention a frothing device 1 for liquid food, hereinafter identified as milk, comprises at least one frothing rotor 3 and at least one motor 2 for rotating the frothing rotor around a rotation axis R and relative to a seat 10.

As previously mentioned, the device 1 can operate with different kinds of milk (animal milk, plant milk), as well as with liquid food adapted to be frothed.

The seat 10 is made so as to substantially entirely contain the frothing rotor 3, and preferably is complementary shaped with respect to the frothing rotor 3. Therefore the seat 10 is the chamber in which milk is frothed.

The rotor 3 is connected to a motor 2, better described below, for rotating the rotor 3 itself at speeds higher than 8000 rpm (typically comprised between 10 and 20 thousand rpm) inside a coaxial seat having a preferably slightly larger radius; therefore, the milk injected in the narrow space between the whipper and the walls of the seat 10 is subjected to high shear strains, resulting in a tiny and uniform dispersion of air in the liquid, or milk, and in formation of the desired froth.

Typically, the frothing rotor 3 has a lower surface 8a, an upper surface 8b and a side surface 8c, all shown in FIG. 1.

Similarly, the seat 10 preferably has a lower surface 18a, an upper surface 18b and a side surface 18c.

The lower surface 18a of the seat 10 faces the lower surface 8a of the frothing rotor 3. The upper surface 18b and the side surface 18c of the seat 10 respectively face, in turn, the side surface 8b and the side surface 8c of the rotor 3.

The seat 10 of the device 1 has at least one inlet 10a and at least one outlet 10b for milk, so as to respectively feed milk to be frothed to the rotor 3 and dispense from the seat 10 the milk frothed by the rotor 3.

This solution allows to define a milk path inside the frothing device 1 and, particularly, allows to precisely direct the milk against the frothing rotor 3 thereby allowing the latter to effectively froth the milk itself.

According to a further preferred aspect of the present invention the distance D2, measured along a direction orthogonal to the rotation axis AR between the outer surface 8d of the frothing rotor 3 and the inner surface (i.e. the side surface 18c) of the seat 10, is at least one order of magnitude smaller with respect to the value of the largest dimension (e.g. the diameter d) of the frothing rotor 3, for example at least 10 times smaller. Preferably, the distance D2 is at least 30 times smaller than the largest dimension, preferably at least 50 times. The “outer surface” 8d of the rotor 3 is the side surface of the cylinder circumscribing the frothing rotor 3 (shown in dotted lines in FIG. 2). If the frothing rotor is cylindrical, the “outer surface” coincides with the side surface 8c of the rotor 3, and the “largest dimension” d of the rotor corresponds to the diameter of the rotor itself. If the rotor is provided with blades 15, for example, as described below and schematically shown in FIG. 2, the outer surface is substantially tangent to the blades themselves, i.e. is constituted by a circle that joins the ends of the blades (FIG. 2).

In case of frustoconical rotor, this largest dimension d coincides with the diameter of the largest base of the rotor. The outer surface coincides with the side surface of a cylinder having this diameter.

Typically, the frothing device 1 is made according to a cylindrical geometry, whereby the seat 10 has a hollow cylindrical shape, whereas the frothing rotor 3 is substantially disk-shaped. Alternatively, the device of the invention is made according to a frustoconical geometry, whereby the seat 10 has a hollow frustoconical shape whereas the frothing rotor 3, in its turn, has a frustoconical shape.

In these cases, the distance D2 is half the value of the difference between the diameter of the frothing rotor 3 and the inner diameter of the seat 10, these diameters being measured on a same plane typically orthogonal to the rotation axis AR.

Preferably, the outlet 10b is positioned at a distance D1 from the rotation axis AR of the rotor itself. Preferably this distance is larger than d/4, where “d” is the largest dimension (diameter) of the rotor 3. As anticipated, this dimension typically coincides with the diameter of the rotor itself. More preferably, this distance is larger than d/3.

In a possible embodiment, the outlet 10b is positioned at the outer portion of the frothing rotor 3. In this embodiment, the distance D1 of the outlet 10 from the rotation axis AR is slightly larger than half the diameter of the rotor 3.

In fact, the milk can be frothed for the most part at the portion of the rotor 3 having a higher rotation speed, i.e. far from the rotation axis AR, for example at the outer portion of the frothing rotor 3. In order to preserve the milk froth, preferably the outlet 10b should be arranged far from the rotation axis AR of the rotor.

Furthermore, in order to increase turbulence of the milk, the outlet 10b can be of small size.

Typically, the outlet 10b has a circular section having the diameter d1 comprised between 1/30 and 1/5 of the largest dimension d of the rotor 3. More preferably, the value of d1 is comprised between 1/20 and 1/10 the value of the largest dimension d (typically the diameter, as afore mentioned) of the rotor 3. In other words, d1/d is comprised between 1/30 and 1/5, preferably 1/20 and 1/10.

Preferred values of the diameter d1 of the outlet 10b are comprised between 2 and 10 mm.

In further possible embodiments, the outlet 10b can have a non-circular section. In this case, the above listed values relate to the ratio of the largest dimension of the section of the outlet 10b to the largest dimension d of the frothing rotor 3.

In other words, in the embodiments where the section of the outlet 10b is not circular, the ratio of the value of the largest dimension of the outlet 10b to the largest dimension d of the frothing rotor 3 is preferably comprised between 1/30 and 1/5, more preferably between 1/20 and 1/10.

The proximity of the outer surface of the frothing rotor 3 to the side surface 18c of the seat 10 contributes to the effectiveness of the milk frothing, facilitating in particular the froth generation.

The distance between the upper surface 8b of the rotor 3 and the upper surface 18b of the seat 10, and/or the distance between the lower surface 8a of the rotor and the lower surface of the seat 10, both measured in axial direction with respect to the frothing rotor 3, are also preferably one order of magnitude smaller than the diameter, or anyway the largest dimension, of the frothing rotor 3.

According to an aspect of the invention, the motor 2 comprises at least one motor rotor 2a and at least one stator 2b. In particular, in a preferred embodiment of the present invention shown in FIG. 1, the motor rotor 2a coincides with the frothing rotor 3. This solution allows to cut the number of structural elements and to save space.

In particular, the present embodiment allows to spare several components, namely a motor rotor separated from the frothing rotor (or rotors), as well as the necessary system for transmitting motion between the two components, for example a drive shaft.

In particular, preferably the motor 2 is an electric motor and therefore the stator 2b comprises a plurality of electric windings 4 arranged along a path, typically a circular-shaped path.

In the embodiment shown in figures, particularly referring to FIG. 3, eight electric windings 4 circularly arranged inside the stator 2b are shown. However, it is clear that, according to the present invention, different number and arrangement of the electric windings 4 can be used. The electric windings 4 are able to generate a time-varying magnetic field, in a way that is known in the art. The frothing rotor 3 is at least partially made of a magnetic material, or otherwise comprises magnetic elements 5, as in the embodiment shown in FIG. 1.

When the frothing rotor 3 is provided with magnetic elements separated and spaced from each other and the stator 2b is powered by electric current, the interaction of the magnetic field generated by the electric windings 4 and the magnetic elements 5 induces a force in the frothing rotor 3, which is rotated.

In particular, in the embodiment of FIG. 1, the frothing rotor 3 is rotated around a pin 6.

According to a first embodiment, the pin 6 is integral with the frothing rotor 3 and is rotatably constrained with respect to the seat 10. Alternatively, as in the embodiment shown in FIG. 1, the pin 6 is integral with the stator 2b. Therefore, the frothing rotor 3 is provided with constraining means adapted to allow it to rotate around the pin 6 itself.

In the embodiment shown in figures, these constraining means comprise a bush 7 adapted to rotatably connect the motor rotor 2a to the pin 6 by inserting the pin 6 itself into said bush 7. Additionally, or alternatively, bearings (not shown) can be used. Sealing means, typically one or more sealing gaskets (for example O-ring, lip seals, precision seals, or the like) 9 are arranged around the pin 6 in order to prevent milk from leaking toward the stator 2b.

According to an aspect of the invention, shown in figures, the magnetic elements 5, or in general areas or portions of the frothing rotor 3 comprising magnetic material, are arranged at a surface 8 substantially facing the stator 2b of the motor 2, when in operative condition.

In the shown embodiment, the stator 2b of the motor 2 and the frothing rotor 3 are arranged in series along the rotation axis AR.

In an alternative embodiment shown in FIG. 4, the stator 2b, and in particular the electric windings 4 are arranged around the frothing rotor 3.

In other words, the electric windings 4 are radially arranged around the rotor 3 externally to the seat 10. In this embodiment, also the magnets 5 of the rotor 3 are radially arranged on the outer surface thereof, so as to face the windings of the stator.

In such an alternative embodiment, the device of the invention takes up more space (i.e. larger dimensions) in radial direction with respect to the embodiment of FIG. 1, thereby providing the advantage of saving space (i.e. smaller dimensions) in axial direction with respect to such an embodiment.

In alternative embodiments not shown, the motor rotor is an element separate from the frothing rotor (or rotors) and operatively connected thereto, for example by means of a drive shaft, preferably having a small length.

In a possible variation of the embodiment of FIG. 1, a motor rotor 2a is made outside the seat 10, for example in a lower position with respect to the seat 10 according to the orientation shown in FIG. 1, and has magnetic elements adapted to rotate the motor rotor 2a. Therefore, the motor rotor 2a drives the rotation of a pin 6 operatively connected to a frothing rotor 3, thereby rotating in turn the frothing rotor 3 itself.

In other words, the motor can comprise a motor rotor 2a made outside the seat 10 and provided with magnetic elements. When magnetic elements are put within a magnetic field, the motor rotor 2a is forced to rotate. The frothing rotor 3 is connected to the motor rotor 2a so that a rotation of the second one involves a rotation of the first one.

A possible alternative is given by an electric motor having a rotor which rotates a drive shaft having the frothing rotor 3 mounted thereon.

In general, the rotor 3 is an element adapted to be rotatably moved within the respective seat 10, i.e. the frothing seat or chamber, in order to froth milk or other liquid food.

As anticipated, the frothing rotor 3 preferably has a cylindrical or frustoconical shape.

In the embodiment of FIGS. 1 and 4, the side surface 8c of the frothing rotor 3 is shown as substantially smooth, i.e. without, or substantially without projections and protrusions.

In a preferred embodiment of the present invention, in order to increase the amount of produced froth, at least part of the side surface 8c of the frothing rotor 3 can be provided with blades 15. The blades 15 are only schematically shown in FIG. 2. The shape of the blades 15 is generally different from what shown. For example, the blades can be bent. Additionally, or alternatively, the blades 15 can form a not null pitch angle with respect to the frothing rotor 3.

Generally the blades 15 configured to allow the milk to be effectively frothed.

In alternative embodiments, not shown in the figures, there are no blades. For example, the frothing rotor can be made up either by means of a single cylindrical, or frustoconical, body or, alternatively, by means of a series of disk-shaped elements concentric to each other and lined up in series, as in a Tesla turbine.

In more detail, the frothing rotor 3 can be composed of a plurality of disks 30, i.e. elements having circular section and small thickness, superimposed to one another and rotatable around the same axis.

Preferably, but not exclusively, these disks have substantially the same diameter.

An embodiment of this rotor is schematically shown in FIG. 4a.

In particular, in this embodiment, the inlet 10a and the outlet 10b of milk are positioned as in the embodiment of FIG. 4a. Although not shown in FIG. 4a, there is the air inlet 10c. Different arrangement, for example that of FIG. 1, can be used.

In a known way, a motor, not shown, rotates the discs 30 of the rotor 3.

As anticipated, the frothing device 1 comprises at least one inlet 10a and at least one outlet 10b for the milk, separated from one another.

According to a preferred embodiment, the milk inlet 10a is in turn connected to a milk feeding duct 11 fluidically connected in turn to a milk source 19 shown in FIG. 7.

As better explained below, the outlet 10b is connected to a dispensing duct 12 of the milk, this duct being adapted to deliver frothed milk to a container or to a subsequent operative step for preparing a beverage, if the milk has to be mixed with one or more ingredients before being dispensed to a user.

It is therefore possible to insert the frothing device 1 in a machine for preparing beverages, able to control in an automated way the operations of the frothing device 1. In particular, the frothing device 1 can be directly inserted in the milk circuit of a machine for preparing beverages, so that the frothing device 1 can receive milk to be frothed and dispense frothed milk.

In a possible embodiment, the frothing rotor 3 leads the milk from the source 19 to the milk inlet 10a. In particular, the rotation of the frothing rotor 3 causes a depression at the milk inlet 10a, which is adapted to draw milk from a source 19 into the seat 10 through the feeding duct 11 and the milk inlet 10a.

In a preferred embodiment shown in FIG. 7 and better described below, there are specific means to lead milk from the source 19 to the milk inlet 10a. For example, a pump 28 can be used to force milk from the source 19 to the frothing device 1.

In the embodiment of FIG. 1, the milk inlet 10a is arranged in radial direction with respect to the frothing rotor 3, whereas the outlet 10b is axially arranged with respect to the frothing rotor 3. Further embodiments are possible wherein the milk inlet 10a is axial and/or the outlet 10b is radial with respect to the frothing rotor 3. As anticipated, the outlet 10b is preferably arranged at a distance D1 from the rotation axis AR of the frothing rotor 3.

The seat 10 of the frothing device 1 further comprises at least one air inlet 10c; this inlet 10c is shown in FIGS. 2 and 7.

In particular, air injection during the frothing process allows the milk to be frothed. In an embodiment, the air injected through the inlet 10c is ambient air. In an embodiment, air is drawn into the seat 10 by the rotation of the rotor 3. In particular, the high speed rotation of the rotor causes a depression inside the seat 10, thereby drawing air into the seat itself through the inlet 10c.

Alternatively, air can be forcibly injected into the frothing device 1, for example by means of a compressor 20 (shown in FIG. 7) or similar means for pressurizing air. For heating the milk, the vapor injection into the device of the invention is preferred.

In a preferred embodiment, the inlet 10c can be used for feeding a mix of vapor and air to the seat 10 of the frothing device 1.

Thus, the injection of vapor and air allows the milk to be heated and frothed. Furthermore, by the periodic and controlled emission of vapor by itself (or vapor and air) after using the frother, it is possible to sterilize the inner surfaces of the frothing device.

Additional embodiments (for example the one in FIG. 7) provide for air inlets 10c separate from the vapor inlets 10d.

According to an aspect of the present invention, shown in figures, the seat 10 is delimited by a base 13 and a cover 14. In particular, the base 13 can be constrained to the stator 2b of the motor 2, preferably in a reversible manner. For example, screws couple the base 13 to the stator 2b. Alternatively, an interlocking coupling or a general shape coupling can be used. The cleaning operations of the component can be facilitated by removing the seat 13 from the stator 2b. It is however possible to constrain the seat to the stator in a substantially irreversible way, for example by gluing or welding.

The cover 14, in its turn, can be reversibly constrained to the seat 13, for example by means of screws, interlocking couplings, shape couplings, etc. In general, the coupling of the cover 14 to the base 13 allows to define the seat 10 in which, in operative condition, the frothing rotor 3 is housed.

In the embodiment shown, the base 13 has a substantially H-shaped section. In particular, the base 13 comprises a support 13a substantially planar and arranged to be orthogonal to the rotation axis AR of the frothing rotor 3. Walls 13c and 13b protrude from both the faces of the support 13a, typically at the perimeter of the support 13a. Thus, the walls 13c and 13b protrude in directions opposite to one another, typically in a direction parallel to the rotation axis R of the rotor 3. In other words, in the embodiment shown the base 13 at least partially defines, in addition to the seat 10 for the frothing rotor 3, a further seat 17 for the stator 2b of the motor 2. In an alternative embodiment wherein the frothing rotor is separate from the motor rotor, thus generally being an element separate from the motor, the seat 17, defined by the circular wall 13b, is used to house this motor.

As anticipated, the frothing device 1 typically has a substantially cylindrical geometry, whereby the support 13a is disk-shaped, whereas the walls 13c and 13b are circular walls. The stator 2b is housed within the wall 13b.

In a variation, the frothing device is frustoconical so that the walls 13b and 13c are tilted with respect to the rotation axis AR of the frothing rotor. The wall 13c defines instead a portion of the seat 10, portion that is complemented by the cover 14. In particular, in the present embodiment the base 13 defines the lower surface 18a and the side surface 18c of the seat 10. The rotor 3 is separated from the stator 2b by the support 13a.

Preferably, the cover 14 can be reversibly constrained to the base 13. In the embodiment shown, the cover 14 has a C-shaped section and is constrainable to the base 13 by interlocking it. In particular, the cover 14 can be constrained to the walls 13c of the base 13 by interlocking it.

In an alternative embodiment not shown in figures, the stator is directly constrained to the support 13a, without the wall 13b.

In the embodiment shown, the lower surface 18a is a surface of the support 13a. The upper surface 18b is a surface of the cover 14 whereas the side surface 18c is a surface of the wall 13c.

In an exemplary embodiment, the lower surface 18a and the upper surface 18b of the seat 10 are substantially flat, or anyway smooth, i.e. without, or substantially without projections or protrusions. One, or both, of them can have projections in order to increase frothing.

If the milk outlet 10b and/or the milk inlet 10a are axial, at least the surface of the seat 10 provided with the outlet 10b, or anyway opposite to the milk inlet 10a (i.e. the upper surface 18b in the figures), is substantially flat or anyway smooth, namely without, or substantially without protrusions or projections.

In the embodiments shown, also the side surface 18c of the seat 10 is flat. In preferred and alternative embodiments, the side surface can be provided with ribs or grooves in order to facilitate the froth to be formed in the milk.

Preferably, these ribs are spaced from the outer surface 8d of the rotor 3. In particular, the ribs preferably are at a distance D2, as above defined, from the ribs of the side surface 18c of the seat 10.

Preferably, also the upper surface 8b and the lower surface 8a of the frothing rotor 3 are preferably substantially flat, smooth or anyway without or substantially without protrusions, at any rate.

Furthermore, the upper surface 18b and/or the lower surface 18a of the seat 10 can be formed by a number of parts tilted with respect to each other. The same applies to the lower 8a and/or upper 8b surface of the rotor 3.

In further embodiments (FIG. 5) a frothing device according to the present invention can comprise one or more seats 110.1, 110.2, each one housing a frothing rotor 103a, 103b. A similar embodiment is shown in FIG. 4, wherein a device 101 has two frothing rotors 103a and 103b.

Referring to FIG. 5, an alternative embodiment of the present invention is herein introduced.

In particular, the device 101 of the present embodiment has two frothing rotors 103a, 103b. The device 101 comprises a structure 120 provided with a milk inlet 110a and a milk outlet 110b. The structure 120 defines two closed seats 110.1 and 110.2 containing the frothing rotors 103a, 103b therein. The two seats 110.1, 110.2 are preferably partitioned by a partitioning wall 113d. The partitioning wall has an opening 116 allowing the milk to pass from the first seat 110.1 to the second seat 110.2.

Moreover, the opening 116 forms a throttling in the milk path between the first seat 110.1 and the second seat 110.2. This throttling helps the frothing process of the milk, promoting the formation of froth.

Similarly to the frothing rotor 3 previously described, the frothing rotors 103a, 103b are preferably rotatable around a pin 106. The pin 106 can be integral with the rotor and rotatable with respect to the structure 120 and thus to the seats 110.1, 110.2, or vice versa.

One or more sealing means 109a, 109b can be mounted on the pin 6 in order to prevent milk from leaking respectively from the second seat 110.2 to the first seat 110.1 and/or from the first seat 110.1 to the motor.

Preferably, the seat 113a of the structure 120 separates the rotors 103a, 103b from a stator of a motor, not shown in detail in FIG. 5 and similar to the stator 2b described in the previous embodiment.

Preferably a first frothing rotor 103a coincides with the motor rotor, similarly to the rotor 3 previously described referring to FIG. 1. According to this exemplary embodiment, the rotor 103a is provided with one or more magnetic elements (not shown) causing the rotor 103a to rotate by electromagnetically interacting with electric windings of a stator of a motor. Preferably, the second frothing rotor 103b is driven to rotation by the first frothing rotor 103a.

In a variation, both the frothing rotors are driven to rotation by the pin 6 operatively connected to a motor, the latter being adapted to rotate the pin 6 itself.

The structure 120 is also provided with at least one air inlet 110c for injecting air therein, for example ambient air or a mix of air and vapor. According to a further preferred aspect, the air inlet is arranged in fluidic communication with a seat 110.2 arranged downstream of at least one additional seat 110.1. If vapor is not fed together with air, a vapor inlet (not shown) is provided. Two air/vapor inlets in the two seats 110.1 and 110.2 are possible.

The definition “downstream” refers to the milk path inside the structure 120. In other words, preferably the air inlet 110c is not arranged at the first rotor 103a met by the milk as it travels along its path within the structure 120.

According to an aspect of the present invention, the structure 120 is made by means of modular seats 110.1, 110.2 which can be separated and assembled to each other. Each modular seat is provided with means for assuring the fluidic communication with one or more different modular seats, so that the number of frothing rotors of the frothing device 101 can be changed as desired. In particular, in variations of the embodiment of FIG. 5 it is possible to arrange in series a plurality of seats 110c having a throttling 116, or anyway a fluidic connection, to the upstream seat. The downstream seat preferably has a cover 114 similar to the cover 14 previously described.

Moreover, in an alternative embodiment of the present invention, the base 113a of the structure 120 is shaped in a similar way to the cover 14 of the first embodiment. Thanks to this, the structure 120 of FIG. 5 can be mounted in series to the frothing device of FIG. 1 after removing the cover 14, thereby obtaining a frothing device having three rotors. In this embodiment an opening is provided on the base 113a, the opening being configured to guarantee the fluidic continuity between the seat 10 of the embodiment of FIG. 1 and the seat 110.1 of the embodiment of FIG. 5. This opening preferably has the same shape as the opening 116 of the wall 113d. Furthermore, in this case the milk inlet 110a can be omitted, or occluded.

In a variation of the embodiment outlined in FIG. 5, two seats 110.1 and 110.2 of the structure 120 are arranged to be in fluidic communication through a duct 116b shown in dotted lines in FIG. 5, whose path at least partially extends outside the seats themselves. In this case there isn't the throttling made by the opening 116.

Thanks to this, several emulsifying stages which can be operated independently of one another, can be obtained, i.e. there can be one or two frothing stages.

In a further variation of the present embodiment, not shown in figures, there isn't the throttling 116 and the seat 110.2 is used for sucking air from the outside and injecting air into the first seat 110.1 provided with a frothing rotor 103a.

The seat 110.2 allows pressure and flow rate of the air injected into the seat 110.1 of the frothing rotor 3 to be increased with respect to the embodiments shown in the preceding figures. For this purpose, the shape of the seat 110.2 and the rotor contained therein can be changed with respect to that shown in figure.

In FIG. 7 a further possible embodiment of a machine for preparing beverages provided with a frothing device according to the invention, is outlined. In particular, FIG. 7 shows a machine provided with the features of the frothing device 1 shown in FIG. 1-4a. Further features, such as the one shown in FIG. 6, may be used in the machine of FIG. 7.

The machine M has a milk source 19, e.g. a container for storing milk at low temperatures (typically 3-5° C.). A milk feeding line 11 connects the source 19 to the frothing device 1. Preferably, the feeding line 11 has means to forcibly feed milk from the source 19 to the frothing device 1. In the embodiment shown, these means comprise a pump 28.

A dispensing duct 12, allowing the frothed milk to be delivered, is connected to the frothing device 1 and in particular to the outlet 10b of the frothing device.

In an embodiment, the milk outlet 10b can have means 29 for adjusting the flow rate of the milk, or other liquid, output from the device. In other words, the milk outlet 10b and/or the dispensing duct 12 can be provided with a portion having a section which can be reduced at will. The throttling created by the means 29 can increase the residence time of the milk inside the device in order to increase the production of froth and/or improve the quality thereof before dispensing milk or other liquid from the frothing device.

Preferably, the size of the throttling 29 can be adjusted. For example, in an embodiment the adjusting means 29 comprise at least one movable element or shutter. In particular, the position of the movable element (or shutter) can be controlled so as to adjust at least one dimension of the outlet 10b and/or the dispensing duct 12 thereby allowing to adjust the section of the outlet; preferably, the means adjust the section of the outlet from closed (totally or partially) to fully open. The throttling can be manually adjusted, for example by operating a knob, or can be controlled by the machine.

In particular, the movable element or shutter can be moved so as to adjust the outlet 10b (i.e. to change its occlusion degree).

For example, in an exemplary embodiment, the portion having a reduced section, i.e. the throttling, is formed on the dispensing duct 12; the duct 12 is made of a plastic material which is at least partially elastically deformable and provided with a “shutter” obtained by means of a motorized cam 29a compressing the milk dispensing duct 12 from the outside. In particular, the duct 12 can comprise a deformable hose, for example made of silicone, having the cam acting thereon so as to reduce the section of the hose itself.

In the embodiment shown is further shown an air feeding duct 21a-21c to feed air to the frothing device 1, in particular to the air inlet 10c. Preferably, the air feeding duct 21a-21c is provided with a compressor 20, or similar means, for pressurizing air and forcing it into the frothing device 1 with controlled flow rate and pressure. In the embodiment shown, a control valve 22 opens and closes the air feeding duct 21a-21c. According to an aspect of the present invention, the air feeding duct 21a-21c is provided with an opening 27 to communicate with the outside environment.

Preferably, the air feeding duct 21a-21c is provided with a non-return valve 23. Typically, this non-return valve 23 is arranged downstream of the control valve 22. Moreover, the machine preferably is provided with a hot-water feeding duct 21b-21c. This duct allows hot water to be injected into the frothing device 1. Typically, water is used for cleaning the frothing device 1. Typically, the hot-water feeding duct 21b-21c is connected to the water boiler (not shown) of the machine for preparing beverages.

Preferably, hot water is put into the frothing device through the air inlet 10c.

In the embodiment shown, the air feeding duct 21a-21c and the hot-water feeding duct 21b-21c share a duct portion, i.e. the portion 21c. In other words, a duct portion 10c is common to the air feeding duct 21a-21c and the hot-water feeding duct 21b-21c.

The portion 21c is preferably connected to the frothing device 1 by the air inlet 10c. The non-return valve 23 of the air feeding duct 21a-21c can prevent the water from reaching the control valve 22 and/or the compressor 20.

The water feeding duct 21b-21c is in turn preferably provided with a control valve 24 to control the opening and closing of the duct itself.

In alternative embodiments, the hot-water feeding duct 21b-21c is not provided. Alternatively, this conduct 21b-21c is independent of the air feeding duct 21a-21c. According to an aspect of the invention, a vapor feeding duct 25 allows vapor to be dispensed inside the frothing device 1. In the embodiment shown, vapor enters the frothing device 1 through a vapor inlet 10d. As anticipated, in different embodiments vapor is mixed with air and injected into the frothing device 1 through the air inlet 10c. For example, the vapor dispensing duct 25 can coincides with the segment 21b of the hot-water feeding duct 21b-21c or can be connected to the segment 21c through the duct 25a shown in dotted lines. In other words, the vapor feeding duct 25 can be connected to the air feeding circuit 21a-21c rather than directly to the frothing device 1. Preferably, a control valve 26 controls the opening/closing of the vapor feeding duct 25.

Hereinafter is illustrated the operation of a frothing device according to the present invention, particularly referring to the frothing device 1 of FIG. 1 and to the machine of FIG. 7. As evident to a field technician, this operation can be altered so as to be applied also to additional embodiments of the present invention, such as the embodiment of FIGS. 4 and 5.

Initially, milk, or in general another liquid food to be frothed, is fed to the frothing device 1.

As anticipated, this operation can be preferably carried out by suitable means, for example a pump 28 forcing the milk.

Then, milk is frothed by means of the rotation of the frothing rotor 3 rotated by the motor 2, which agitates milk, thereby causing the milk to mix with the air in the seat 10, coming through the duct 21a.

As previously described, the frothing rotor 3 is preferably rotated by means of the magnetic field generated by the electric windings of the stator 2b, which induce a force on the magnetic elements of the frothing rotor 3.

In alternative embodiments, the motor is separate from the frothing rotor. Special means for transmitting motion, such a drive shaft, transfer motion from the motor to the frothing rotor.

As anticipated, in order to carry out the frothing, the frothing rotor is rotated at high speed. In particular, preferably the frothing rotor is rotated at a maximum speed of at least 8,000 rpm, and even up to 15,000 rpm.

In an embodiment, the frothing rotor 3 is rotated at speeds higher than 8,000 rpm. Preferably, the rotation speed of the frothing rotor 3 is comprised between 10,000 and 20,000 rpm.

The high tangential velocity, together with the small distance D2 between the frothing rotor 3 and the seat 10, allows a high frothing quality to be obtained. Also the small size of the outlet 10b takes part in generating turbulence in the milk, thereby allowing a high frothing quality to be obtained.

According to a further object of the invention, such a high speed may be maintained only for part of the total frothing time. In particular, preferably the rotational speed of the frothing rotor (or rotors) 3 is electronically controlled.

In more detail, the rotation speed of the frothing rotor 3 can be programmed depending on the kind of processed liquid and, possibly, also depending on its temperature, and can be changed according to a proper pattern in a single frothing cycle.

In other words, the speed of the frothing rotor 3 can be changed during the frothing process; this change allows a continuous action on the desired frothing degree of the processed liquid.

For example, the frothing rotor 3 is rotated so as to have a first speed v 1 during the initial frothing step; then, the frothing rotor 3 is rotated at a second speed v2 higher than the speed v1; finally, the frothing rotor 3 is rotated again at the speed v1 during the last frothing step. This operating scheme is shown in FIG. 6.

The operation of the present invention contemplates different speed sequences.

An electronic controller, known in the art, allows fine and continuous adjustment of the speed of the motor 2 and therefore of the frothing rotor 3. The speed change of the frothing rotor 3 during frothing, together with the injection of ambient air and/or vapor to heat the liquid, allows a beverage having high quality froth to be obtained and, if necessary, the adjustment of the final temperature of the beverage itself.

According to an embodiment of the present invention, the frothing rotor can be alternately rotated in either rotation ways around the respective rotation axis AR. In particular, the change of the rotation way of the frothing rotor 3 has proven to be particularly effective during the cleaning operations with hot water or vapor, better described later.

As anticipated, air can be caught from the outside environment, at ambient pressure or specifically pressurized. Air injection allows the milk to be frothed. If air is injected into the seat 10 as mixed with water vapor, then the milk can be simultaneously heated and frothed.

In other words, by means of the action of the frothing rotor 3 combined with the air injected through the air inlet 10c, cold frothed milk can be dispensed.

Alternatively, hot frothed milk can be dispensed, by the action of the frothing rotor 3 together with vapor injected through the air inlet 10c, mixed with air, or by a vapor inlet 10d separate from the air inlet 10c.

After frothing, milk is conveyed to the outlet 10b and then channeled in the dispensing duct 12.

Automatic cleaning cycles can be also provided, by injecting vapor into the frothing device 1, for example through the air inlet 10c or the vapor inlet 10d, if there is one. Furthermore, a cleaning cycle can comprise, additionally or alternatively to vapor conveyance, washing the device 1 by hot water, for example supplied through the air inlet 10c in the embodiment shown in FIG. 7.

In order to make a more thorough cleaning, the various components of the frothing device 1 can be disassembled, and in particular the cover 14 can be removed from the base 13, the frothing rotor 3 from the base 13, and the base 13 from the stator 2b, so as to be able to individually clean with accuracy the various components of the frothing device 1.

A frothing device 1 according to the present invention is advantageously used in a machine for preparing beverages, in particular in a machine for dispensing milk or a machine for preparing milk-based beverages, such as chocolate, cappuccino, latte macchiato, etc.

1. A device for frothing milk and liquid food, comprising a frothing rotor and a motor adapted to rotate said frothing rotor, further comprising a seat adapted to substantially entirely contain said frothing rotor, an inlet for feeding said milk or liquid food into said seat, one or more air inlets and an outlet of said milk or liquid food from said seat, said outlet being separated from said milk inlet.

2. The device according to claim 1, wherein said rotor and said seat have complementary shapes.

3. The device according to claim 1, comprising an inlet to let in vapor inside said seat.

4. The device according to claim 1, wherein said motor comprises a stator and a motor rotor, wherein said motor rotor is the frothing rotor housed in said seat.

5. The device according to claim 1, wherein part of the side surface of the rotor comprises blades.

6. The device according to claim 4, wherein said stator comprises a plurality of electric windings and said motor rotor comprises a portion made of magnetic material, said windings preferably being at least partially arranged along a circular path, below or to the side of said frothing rotor.

7. The device according to claim 1, wherein the section of said outlet is substantially circular and the ratio d1/d of the diameter of said outlet (d1) to the diameter (d) of said rotor is between 1/30 and 1/5, preferably between 1/20 and 1/10.

8. The device according to claim 1, wherein said outlet is arranged at a distance (D1) from the rotation axis (AR) of said frothing rotor, and wherein said distance (D1) is larger than ¼ of the diameter (d) of said frothing rotor, preferably larger than ⅓ of the diameter (d) of said frothing rotor.

9. The device according to claim 8, wherein said outlet is arranged at the side surface of said rotor.

10. The device according to claim 1 wherein said seat is at least partially defined by a base and a cover, the latter being separable from said base.

11. The device according to claim 1, wherein said frothing rotor is removably mounted around a pin, said pin being integral with said seat or said motor.

12. The device according to claim 1, wherein said liquid inlets is are arranged radially with respect to said frothing rotor, and said outlets are arranged axially with respect to said frothing rotor.

13. The device according to claim 1, comprising a plurality of said seats arranged in series, said seats being removably mounted on said stator and preferably in series, in order to allow them to be disassembled and reassembled.

14. The device according to claim 13, wherein a fluidic throttling is arranged between a first seat and a second seat of said seats, said second seat being sequentially arranged relative to said first seat.

15. The device according to claim 1, wherein the distance (D) between the outer surface of the frothing rotor and the side surface of said seat is at least 10 times smaller and up to 50 times smaller than the value of the largest dimension of said frothing rotor.

16. The device according to claim 1 wherein, during frothing, said frothing rotor is rotatable at different speeds.

17. The device according to claim 1, further comprising means for adjusting the flow rate of liquid output from the device.

18. A machine for preparing beverages, having a device for frothing milk comprising a frothing rotor, a motor to rotate said frothing rotor, and a seat adapted to substantially entirely contain said frothing rotor, an inlet for feeding said milk into said seat, air inlets and an outlet of said milk from said seat, said outlet being separated from said milk inlet, said machine comprising a milk feeding duct to feed milk to said frothing device, an air feeding duct to feed air to said frothing device, and an output duct from said device for dispensing said frothed milk.

19. The machine according to claim 18, comprising a pump for feeding said milk to said frothing device.

20. The machine according to claim 18, comprising pressurizing means to pressurize said air.

21. The machine according to claim 18, comprising means for adjusting the flow rate of the liquid output from said device, said means further comprising a deformable dispensing duct and a cam acting on said duct.

22. A method for preparing a beverage in a machine, wherein milk or liquid is frothed in a device according to claim 1 comprising the steps of:
a) feeding liquid to said device through a milk feeding duct;
b) feeding air to said device through said air feeding duct;
c) rotating said frothing rotor within said seat, in order to froth said liquid; and
d) dispensing said frothed liquid from said device.

23. The method according to claim 22, wherein the flow rate of the liquid output from said device is controlled.

24. The method according to claim 22, comprising the step of feeding vapor to said device in order to heat milk.

25. The method according to claim 22, wherein said rotor is rotated and reaches a speed of at least 8000 revolutions per minute.

26. The method according to claim 25, wherein said rotor reaches a maximum speed higher than 8000 revolutions per minute.
